(19) United States
(12) Patent Application Publication
(10) Pub. No.: US 2025/0204335 A1
(43) Pub. Date: Jun. 26, 2025

(54) PROCESS TO REDUCE THE TEMPERATURE IN A GREENHOUSE

(71) Applicant: VAN DER HOEVEN HORTICULTURAL PROJECTS B.V., Den Hoorn (NL)

(72) Inventors: Vincent Martijn KICKERT, Den Haag (NL); Marcus Gerardus MIDDELDORP, Den Hoorn (NL); Tjeerd Wim TIJSMA, Den Hoorn (NL)

(21) Appl. No.: 18/851,159

(22) PCT Filed: Apr. 6, 2023
(86) PCT No.: PCT/EP2023/059213

§ 371 Date: Sep. 26, 2024

(30) Foreign Application Priority Data
Apr. 6, 2022 (NL) 2031517
Dec. 22, 2022 (NL) 2033792

(51) Int. Cl. A01G 9/24

(52) U.S. Cl. CPC A01G 9/246

(57) ABSTRACT

The invention is directed to a greenhouse (1) and process for reducing or maintaining the temperature in a growing space (8) as comprised in a greenhouse (1) and comprising the following steps: (a) collecting ambient air, air from the growing space (8) and/or mixtures of ambient air and air from the growing space (8) to obtain feed air. (b) reducing a source of water to a lower temperature by indirect heat exchange against a cooling medium to obtain chilled water. (c) directly contacting part of the feed air with the chilled water wherein the temperature of the chilled water is lower than the dew point of the feed air wherein the feed air is cooled thereby obtaining cooled air as a conditioned air and a used chilled water and discharging the conditioned air to the growing space (8).

The invention is directed to a process to reduce or maintain the temperature in a growing space as comprised in a greenhouse.

Such a process is described in WO2008/002686. This publication describes a greenhouse provided with a space at the end gable wall in which ambient air and/or greenhouse recirculating air is collected and distributed in a growing section via a multitude of parallel ventilation tubes. According to this publication the interior of the greenhouse may be reduced in temperature by drawing in ambient air via a pad cooling system arranged at the inlet for ambient air in the gable end wall and distributing this air via the ventilation tubes.

JP20156133 describes a greenhouse with a space at the end gable wall in which ambient air and/or greenhouse recirculating air is collected and distributed in a growing section via a multitude of parallel ventilation tubes. Ambient air, optionally in admixture with greenhouse recirculating air, passes a water pad before being distributed in the growing section. Optionally greenhouse recirculating air may be mixed with the air which has passed the water pad before being distributed in the growing section.

Controlling the climate in a greenhouse by using ambient air and greenhouse recirculating air is known for many years and for example described in U.S. Pat. No. 3,404,618 published in 1968. In this publication ventilation tubes are described which distribute ambient air, recirculating greenhouse air or combinations into the growing area of a greenhouse. Cooling may be achieved by drawing in air through water-cooled pads.

WO2017/176114 describes a greenhouse where ambient air is cooled by first contacting air with liquid water to obtain a cooled and saturated air flow in an evaporative pad. This air flow is subsequently contacted with an aqueous 1,2-propanediol solution to dry the air. The dry air is contacted with water to obtain a cooled air. This cooled air is distributed to a growing section via ventilation tubes.

A disadvantage of the prior art processes is that the cooling by means of water pads is sometimes insufficient, especially in situations wherein the relative humidity of the ambient air is high. The object of the present invention is to provide a process and system for reducing the temperature or maintaining a temperature in a growing space as comprised in a greenhouse. More especially the process should be able to operate in situations where the relative humidity of the ambient air is high.

This is achieved by the following process. Process to reduce or maintain the temperature in a growing space as comprised in a greenhouse and comprising the following steps,
(a) collecting ambient air, air from the growing space and/or mixtures of ambient air and air from the growing space to obtain feed air,
(b) reducing a source of water to a lower temperature by indirect heat exchange against a cooling medium to obtain chilled water,
(c) directly contacting part of the feed air with the chilled water wherein the temperature of the chilled water is lower than the dew point of the feed air wherein the feed air is cooled thereby obtaining cooled air as a conditioned air and a used chilled water and discharging the conditioned air to the growing space.

Applicants found that with such a process the temperature in a growing space can be reduced or kept at a desired low temperature even when the relative humidity of the ambient air is high. When for example ambient air having a high relative humidity is cooled according to this process the water as present in the air will condense. This water may advantageously be used as irrigation water. Because the cooling medium is not in direct contact with the water which contacts the air no contamination of the air by the cooling medium is possible. This allows one to use the most optimal cooling medium in terms of energy efficiency. Further advantages will be discussed when describing the preferred embodiments below.

The feed air in the process may be ambient air, air from the growing space and/or mixtures of ambient air and air from the growing space and suitably ambient air or mixtures of ambient air and air from the growing space. The ambient air may have a temperature of between 18° C. and 40° C. and a relative humidity of above 50% and suitably between 50% and 80% It is at these temperatures and relative humidity properties of the ambient air that the advantages of the present process are the most prominent. The wet bulb temperature of the ambient air is suitably equal to or higher than the dry bulb temperature of the air from the growing space.

The source of water in step (b) may be for example potable water, rain water, sourced from surface and/or sub-surface reservoirs and/or non conventional resources such as industrial treated waste water. Preferably the chilled water which has been used to cool the source of water is reused as the source of water in step (b). In this manner the use of fresh sources of water is limited. In order to avoid a build up of salts in such a recirculating water flow part of the water is purged from this recirculating water flow. The amount of water which is purged may be made up by adding fresh water to the recirculating water flow, which fresh water may be for example any of the sources mentioned before. Part of the water as present in the feed air will condense in step (c) to become part of the used chilled water. This amount of water may be sufficient to make up for the amount of water which is purged. In such a situation no or very less fresh water as described above will be required to be added to the recirculating flow of water. Preferably at least the amount of water which condenses from the feed air is used as irrigation water in the growing space.

The irrigation water as obtained may be supplemented by other sources of fresh water before being supplied to plants as present in the growing section. This water may be treated before being supplied to the plants for example to reduce any mineral ions, bacteria, biofilms, yeasts or other microorganisms which may be present in the water. Examples of suitable treatments are UV treatment and/or thermal treatments. Other treatments which may be used alone or in combination with one of the mentioned treatments are for example addition or in situ generation of ozone, chlorine, hypochlorite and hydrogen peroxide; membrane filtration, electrodialysis and ultrasonic noise treatment. An example of a suitable treatment is the addition of thermal and non-thermal plasma activated water which comprises nitrites and hydrogen peroxide compounds as described in US2018/0327283. Such a process is capable of reducing the undesired bacteria, biofilms, yeasts or other microorganisms while also providing nitrogen species which may act as a fertiliser.

In this step (b) chilled water, is obtained by reducing the source of water to a lower temperature by indirect heat exchange against a cooling medium. Such a cooling medium may be an evaporating liquid, such as evaporating ammonia, or may be a liquid or gas having a lower temperature than the temperature of the chilled water. The cooling medium is preferably present in a closed circuit in which it circulates and is reused as cooling medium. Suitable cooling media are ammonia and refrigerant gasses.

The indirect heat exchange in step (b) may be performed in well known heat exchange equipment such as for example a shell and tube heat exchangers or a plate heat exchanger.

Step (b) is preferably performed making use of a heat pump. The heat pump suitably transfers thermal energy from a first thermal carrier fluid, preferably water, using a refrigeration cycle to a second thermal carrier fluid, preferably water, acting as a heat sink to obtain the cooling medium for use in step (b) and a heated second thermal carrier fluid. The first thermal carrier fluid acting as a heat sink may be air when the heat exchange takes place in so-called dry-coolers. These dry-coolers include fans to direct the air along a heat exchange surface. This is energy intensive and the dry-coolers require a large building area. For this reason it is preferred to use a fluid, preferably water, as the heat sink resulting in that a heated second thermal carrier fluid, preferably heated water, is prepared. This heat exchange can be performed in much smaller equipment and it does not require the amount of energy as in the aforementioned dry-coolers.

A problem is that a heated second thermal carrier fluid, eg heated water, is obtained which has to be discharged. Applicants have now found that the heated second thermal carrier fluid, eg heated water, can be used to obtain a source of heated water by means of indirect heat exchange. The source of heated water is used to cool the temperature of feed air during daytime by directly contacting the feed air with this source of heated water.

Thus preferably step (c) is performed during part or all of the night and wherein during part or all of the day in a step (c2) part of the feed air is contacted with a source of heated water such that the feed air is cooled to a temperature close to the wet-bulb temperature by evaporation of part of the source of heated water thereby obtaining cooled air as a conditioned air and discharging the conditioned air to the growing space and wherein the source of heated water is obtained in a step (b2) by indirect heat exchange against the heated second thermal carrier fluid.

The direct contacting in step (c2) suitably takes place in a vertically extending wetted screen through which the source of heated water runs downwards and the feed air passes the wetted screen in a transverse direction. More suitably the same wetted screens are used in step (c1) and (c2).

The contacting of the feed air and the chilled water as in step (c) is performed during part or all of the night and the contacting of the feed air and the source of heated water is performed during part or all of the day. This method is especially advantageous in the spring, summer and autumn when cooling during the night and day may be required. For this the night is defined as between 6 pm and 6 am and the day is defined as between 6 am and 6 pm local time.

The invention is therefore also directed to a process to reduce or maintain the temperature in a growing space as comprised in a greenhouse and comprising the following steps,
(a) collecting ambient air, air from the growing space and/or mixtures of ambient air and air from the growing space to obtain feed air,
(b) obtaining a cooling medium and a heated second thermal carrier fluid by means of a heat pump, wherein the heat pump transfers thermal energy from a first thermal carrier fluid (preferably water) using a refrigeration cycle to a second thermal carrier fluid (preferably water) acting as a heat sink to obtain the cooling medium and the heated second thermal carrier fluid,
(b1) obtaining a chilled water by reducing a first source of water to a lower temperature by indirect heat exchange against the cooling medium,
(b2) obtaining a source of heated water by indirect heat exchange against the heated second thermal carrier fluid,
(c1) directly contacting part of the feed air with the chilled water obtained in step (b1) during part or all of the night wherein the temperature of the chilled water is lower than the dew point of the feed air and wherein the feed air is cooled thereby obtaining cooled air as a conditioned air and a used chilled water and discharging the conditioned air to the growing space and
(c2) directly contacting part of the feed air with the source of heated water obtained in step (b2) during part or all of the day wherein the feed air is cooled to a temperature close to the wet-bulb temperature by evaporation of part of the source of heated water thereby obtaining cooled air as a conditioned air and discharging the conditioned air to the growing space.

The temperature of the chilled water is suitably more than 5° C. below the dew point of the feed air and preferably more than 10° C. below the dew point of the feed air. Preferably the temperature of the chilled water is between 5 and 10° C.

The direct contacting in step (c) suitably takes place in a vertically extending wetted screen through which the chilled water runs downwards and the feed air passes the wetted screen in a transverse direction. These wetted screens are also known as water pads or evaporating pads. The wetted screens are suitably vertically positioned wetted screens through which the chilled water flows from its upper end to its lower end and the feed air passes the screen in a substantially horizontal flow direction. The feed air directly contacts the chilled water in the pad. Because the temperature of the chilled water is lower than the dew point of the feed air water will condense from the feed air to become part of the used chilled water. Examples of such vertically extending wetted screen are described in WO2004/068051, EP1659357 and U.S. Pat. No. 5,966,953.

The humidity of the cooled air will be high to even up to 100% relative humidity. This may be a too high humidity for the cooled air to be directly discharged to the growing space as conditioned air. The humidity of the conditioned air may suitably be lowered by diluting the cooled air with air which is not subjected to the contacting with chilled water of step (c). More preferably in a separate step (d) ambient air, air from the growing space and/or mixtures of ambient air and air from the growing space which is not subjected to the contacting with chilled water of step (c) is mixed with the cooled air to obtain the conditioned air. Even more preferably the ambient air, air from the growing space and/or mixtures of ambient air and air from the growing space which is not subjected to the contacting with chilled water of step (c) is increased in temperature before mixing with the cooled air. In this manner the relative humidity of the resulting conditioned air can be even more lowered.

The above process may be performed in any greenhouse where ambient air is reduced in temperature before being introduced to a growing section of the greenhouse. More suitably the process is performed in a semi-closed greenhouse as for example described in the afore mentioned WO2008/002686, JP20156133 and WO2017/176114.

When a greenhouse is provided with the means to prepare chilled water and especially also a source of heated water as described above it may also be used to dehumidify the air in the growing section of the greenhouse. This may be performed by the following process. Process to dehumidify the air as present in a growing space as comprised in a greenhouse and comprising the following steps,
(b) obtaining a cooling medium and a heated second thermal carrier fluid by means of a heat pump, wherein the heat pump transfers thermal energy from a first thermal carrier fluid, preferably water, using a refrigeration cycle to a second thermal carrier fluid, preferably water, acting as a heat sink to obtain the cooling medium and the heated second thermal carrier fluid,
(b1) obtaining a chilled water by reducing a first source of water to a lower temperature by indirect heat exchange against the cooling medium,
(cc) directly contacting part of the air from the growing section with the chilled water obtained in step (b1) in a vertically extending wetted screen through which the chilled water runs downwards and the air from the growing section passes the wetted screen in a transverse direction and wherein the temperature of the chilled water is lower than the dew point of the air from the growing section thereby obtaining dehumidified air and discharging the dehumidified air into the growing section.

The above process is advantageous because less air has to be vented from the greenhouse to reduce the absolute humidity. Thus also less heat and less carbon dioxide will be lost and consequently less carbon dioxide is required to be added to the greenhouse.

The heated second thermal carrier fluid as obtained in the above air dehumidify process is suitably directly or via another heat carrier used to heat up the air, irrigation water and/or any plants in the growing section.

The dehumified air obtained in step (cc) may be heated before discharging or after discharging this air into the growing section. This heating may be performed by indirect heat exchange against the heated second thermal carrier fluid.

The greenhouse according to the invention as here described is preferably used to perform the process according to the invention in summer and to perform the air dehumidify process as described above in spring, fall and/or winter. This allows one to make efficient use of the greenhouse in different seasons.

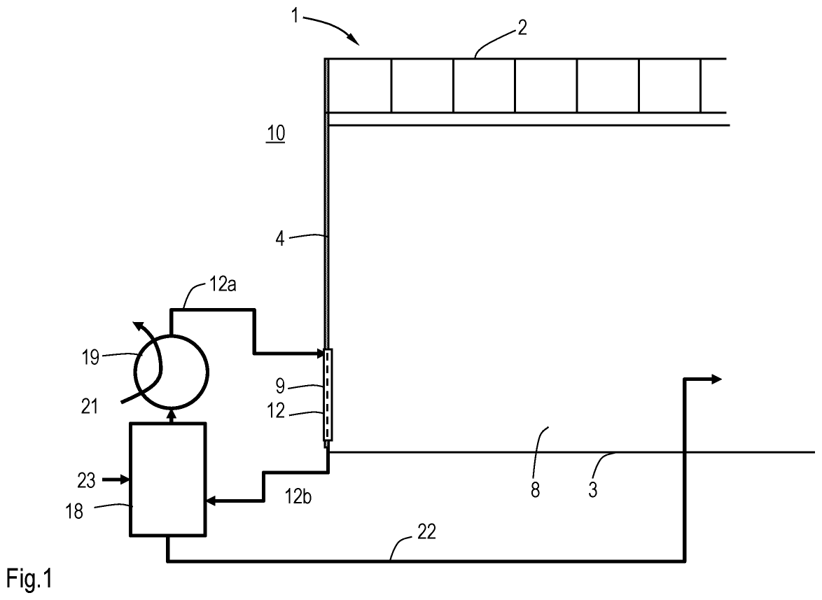

The above described process may be performed in a greenhouse as shown in FIGS. 1-3. FIG. 1 shows a greenhouse provided with a saddle roof (2), a floor (3), two end walls (4), two side walls (5). The interior of the greenhouse (1) is a growing space (8) where a cultivation can grow, such as vine crops, flowers, leafy greens and the like. Along one end wall (4) a row of openings (9) to the exterior (10) is provided for entry of ambient air directly into the growing space (8). The openings (9) may be closable openings. The flow of ambient air into the greenhouse may be effected by ventilators positioned at the opposite end wall (4) which draw air from within the growing space to the ambient (10) (not shown in this Figure). The closable opening or openings (9) are provided with one or more water pads (12). The water pads (12) for performing step (c) are connected to a supply conduit (12a) for supply of chilled water and to a discharge conduit (12b) for discharge of used chilled water. The supply conduit (12a) for supply of chilled water is fluidly connected to an indirect heat exchanger (19) for cooling a source of water. The discharge conduit (12b) for discharge of used chilled water is fluidly connected to a storage vessel (18). From this storage vessel (18) water is supplied to the indirect heat exchanger (19) where the water is cooled to obtain chilled water against a cooling medium (21). From the storage vessel (18) water is purged via conduit (22) to be used as irrigation water in growing space (8). Fresh water may be added to storage vessel (18) via supply (23).

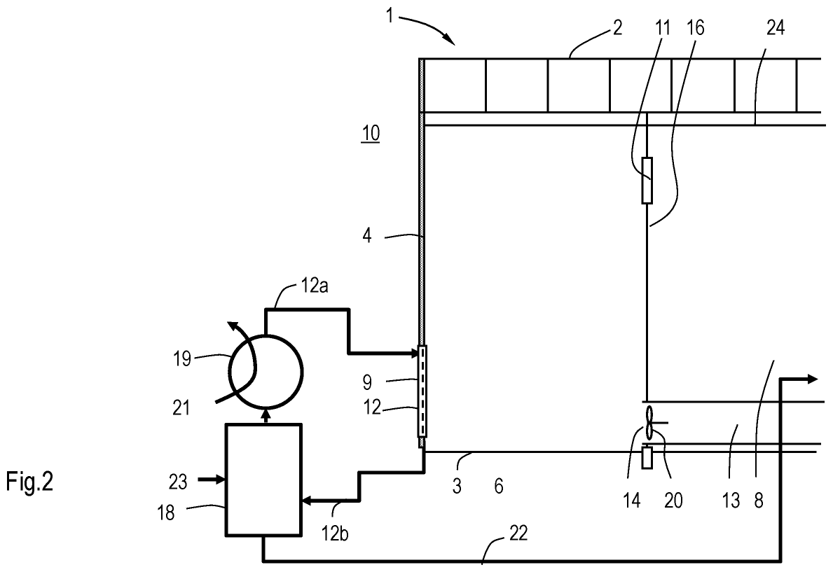

FIG. 2 shows a variant of the greenhouse of FIG. 1 wherein an elongated mixing space (6) is present which runs as a corridor along the length of end wall (4). Between the mixing space (6) and growing space (8) a partition wall (16) is present. At the upper end of this partition wall (16) and below the trusses (24) which forms part of the roof structure of the saddle roof (2) a closable opening or openings (11) are present along the length of the partition wall (16). The growing space (8) comprises a multitude of parallel ventilation conduits (13). Each conduit (13) has an air inlet (14) provided with a ventilator (20) to draw in air from the mixing space (6). The conduits (13), which are suitably tubes made of a flexible material, are provided with openings along its length to uniformly distribute air in the growing space.

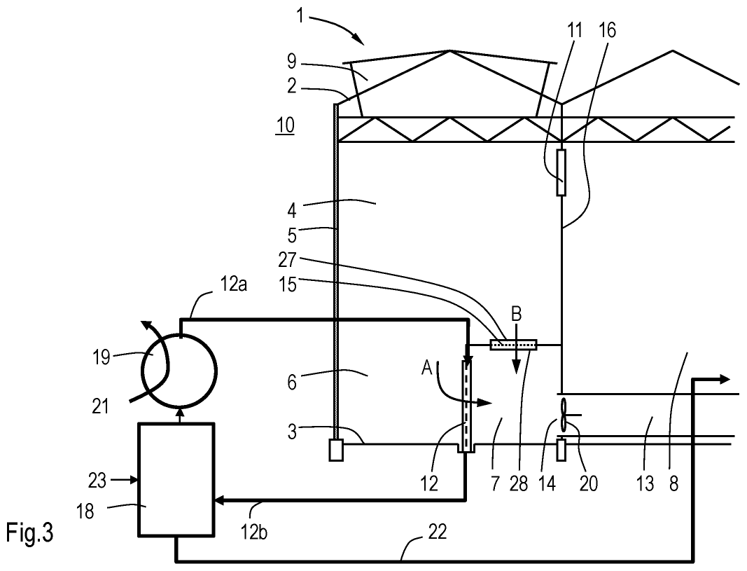

FIG. 3 is a variant of the greenhouse shown in FIG. 2. In this greenhouse a mixing space (6) runs along a side wall (5). The mixing space (6) is fluidly connected to the exterior (10) of the greenhouse by means of one or more openings (9) for ambient air in the roof (2). Alternatively the openings (9) to the exterior (10) of the greenhouse for ambient air of the mixing space (6) may be openings in one of the side walls (5). The mixing space (6) is also fluidly connected to the growing space by means of one or more openings (11) as present in the upper half end of partition wall (16).

Next to mixing space (6) a space for conditioned air (7) is shown. The mixing space (6) and the space (7) for conditioned air is separated from a growing space (8) as present within the greenhouse (1) by the partition wall (16). The mixing space (6) and the space (7) for conditioned air are fluidly connected via one or more water pads (12) for performing step (c) and via a parallel air flow path (A) wherein the water pads (12) are positioned parallel to the parallel flow path (B). The parallel air flow path (B) comprises one or more indirect heating units (15) for performing step (d). The parallel air flow path (B) is provided with air displacement means (27). Such a design having the two parallel air flows (A and (B) allows one to obtain conditioned air having the desired low temperature and an acceptable relative humidity.

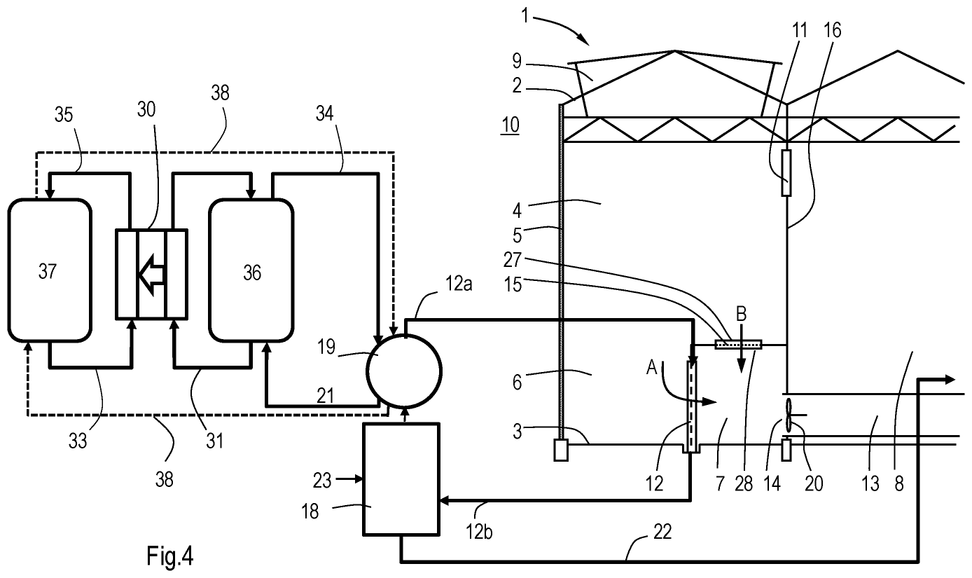

FIG. 4 shows a greenhouse as in FIG. 3. Also a heat pump (30) is shown which transfers thermal energy from a first thermal carrier fluid (31) using a refrigeration cycle to a second thermal carrier fluid (33) acting as a heat sink to obtain the cooling medium (34) for use in step (b) and a heated second thermal carrier fluid (35). The cooled medium (34) is stored in storage vessel (36) and the heated second thermal fluid is stored in storage vessel (37). During the night cooled medium (34) as collected and stored in vessel (36) during the day is used to cool a source of water in heat exchanger (19) via a circulating circuit (38). The cooled and heated water obtained in heat exchanger (19) is fed to the one or more water pads (12) as in FIGS. 1-3. The greenhouse of FIG. 4 may also be used for the process to dehumidify air according to this invention. The heat pump (30) may also be combined with the greenhouses shown in FIGS. 1-3.

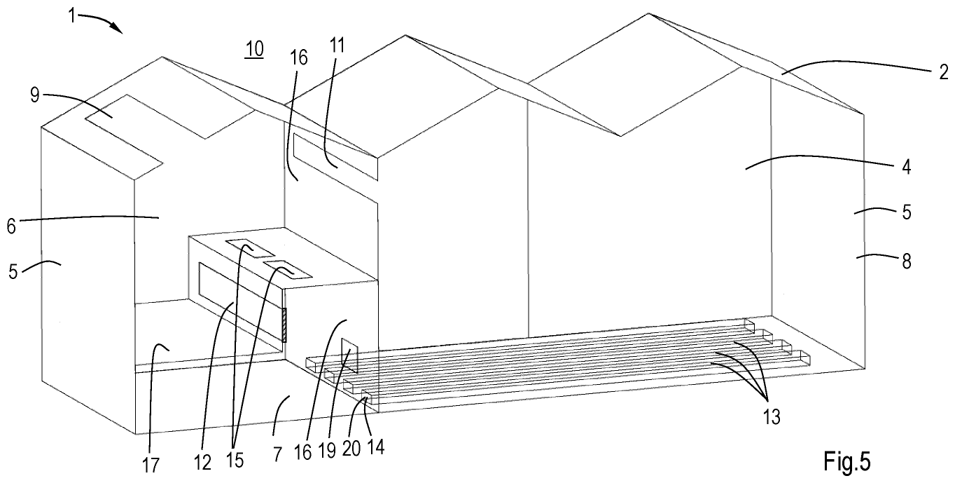

FIG. 5 is a greenhouse as in FIGS. 3 and 4 as seen in a three dimensional view. A difference is that an elevated floor (17) is present. This elevated floor (17) enables one to provide for an emergency door (19).

### EXAMPLE 1

A greenhouse according to FIG. 1 is simulated wherein ambient air (10) of 36° C. and a relative humidity of 60% is used. The air in the growing section (8) has a temperature of 28° C. and has a relative humidity (RH) of 80%. The control object in this example is to reduce the temperature of the air in the growing section (8) and not increasing the absolute humidity by providing ambient air via the water pads (12) into the growing section.

In the water pads (12) the ambient air is contacted with chilled water having a temperature of 7° C. The air which leaves the water pads (12) and enters the greenhouse has a temperature of 27° C. and a relative humidity of at least 90%.

In effect part of the water as present in the ambient air condenses in the water pads due to the use of chilled water.

### Comparative Experiment A

Example 1 is repeated except that in the water pads (12) the ambient air is contacted with water having a temperature of 20° C. This water is not chilled or cooled prior to contacting with the ambient air. The air which leaves the water pads (12) and enters the greenhouse has a temperature of 29.5° C. and a relative humidity of 95%.

In effect part of the liquid water evaporates and becomes part of the air which leaves the water pads (12) and enters the greenhouse.

### EXAMPLE 2

A greenhouse according to FIG. 3 is simulated wherein ambient air (10) of 36° C. and a relative humidity of 70% is used. The air in the growing section (8) has a temperature of 28° C. and has a relative humidity (RH) of 80%. The control object in this example is to reduce the temperature of the air in the growing section (8) by providing ambient air via the water pads (12) into the growing section.

In the mixing space (6) 3 volume parts of the ambient air (10) is mixed with 7 volume parts which enter the mixing space from the growing section (8) via openings (11). The air mixture, referred to as the feed air, obtained in mixing space (6) has a temperature of 30.5° C. and a relative humidity of 78%. Of this feed air 90 vol % is contacted with liquid water having a temperature of 6° C. in the water pads (12) to obtain humid air having a temperature of 20° C. and a relative humidity of 100%. The remaining 20 vol. % of the feed air bypasses or said otherwise circumvents the water pads (12) via parallel air flow path (B) (as in FIG. 3) and is mixed with the humid air to obtain conditioned air having a temperature of 22° C. and a relative humidity of 95. %. In this example the air in parallel air flow path (B) is not heated. The conditioned air which is discharged into the growing section via tubes (13) has a temperature of 22° C. and a relative humidity of 95%.

### EXAMPLE 3

Example 2 is repeated except that the air in parallel air flow path (B) is heated increasing its enthalpy by about 5 kJ/kg. The temperature of the resulting conditioned air in space (7) is 24.7° C. and the relative humidity (RH) is 86%. As in Example 2 the conditioned air has a lower temperature than the air in the growing section and is thus suited to reduce the temperature in the growing section (8) when supplied to said growing section via ventilation conduits (13).

### Comparative Experiment B

This calculated experiment will show how the same ambient air of examples 2 and 3 is used to cool the air in the growing section having the same starting conditions as in Examples 2 and 3 in a greenhouse as in FIG. 2. In the water pads the ambient air is contacted with water having a temperature of 20° C. The resulting mixture in mixing space (6) has a temperature of 27.3° C. and a relative humidity of 95%. In order to obtain the same relative humidity as in example 2 or 3, this air has to be heated up to 28.5° C. at which point cooling of the growing section (8) becomes impossible.

1. A process to reduce or maintain the temperature in a growing space as comprised in a greenhouse and comprising the following steps,
(a) collecting ambient air, air from the growing space and/or mixtures of ambient air and air from the growing space to obtain feed air,
(b) reducing a source of water to a lower temperature by indirect heat exchange against a cooling medium to obtain chilled water,
(c) directly contacting part of the feed air with the chilled water wherein the temperature of the chilled water is lower than the dew point of the feed air wherein the feed air is cooled thereby obtaining cooled air as a conditioned air and a used chilled water and discharging the conditioned air to the growing space.

2. The process according to claim 1, wherein in a separate step (d) ambient air, air from the growing space and/or mixtures of ambient air and air from the growing space which is not subjected to a step (c) is mixed with the cooled air to obtain the conditioned air.

3. The process according to claim 2, wherein the ambient air, air from the growing space and/or mixtures of ambient air and air from the growing space which is not subjected to a step (c) is increased in temperature before mixing with the cooled air.

4. The process according to claim 1, wherein the direct contacting in step (c) takes place in a vertically extending wetted screen through which the chilled water runs downwards and the feed air passes the wetted screen in a transverse direction.

5. The process according to claim 1, wherein the chilled water is more than 5° C. below the dew point of the feed air.

6. The process according to claim 1, wherein the relative humidity of the ambient air is above 50% and the wet bulb temperature of the ambient air is equal to or higher than the dry bulb temperature of the greenhouse air.

7. The process according to claim 1, wherein the temperature of the chilled water is between 5 and 10° C.

8. The process according to claim 1, wherein the used chilled water is the source of water in step (b).

9. The process according to claim 1, wherein water as present in the feed air condenses in step (c) to become part of the used chilled water.

10. The process according to claim 9, wherein part or all of the used chilled water is used as irrigation water in the growing space.

11. The process according to claim 1, wherein step (b) is performed by making use of a heat pump.

12. The process according to claim 11, wherein the heat pump transfers thermal energy from a first thermal carrier fluid (preferably water) using a refrigeration cycle to a second thermal carrier fluid (preferably water) acting as a heat sink to obtain the cooling medium for use in step (b) and a heated second thermal carrier fluid.

13. The process according to claim 12, wherein step (c) is performed during part or all of the night and wherein during part or all of the day in a step (c2) part of the feed air is contacted with a source of heated water such that the feed air is cooled to a temperature close to the wet-bulb temperature by evaporation of part of the source of heated water thereby obtaining cooled air as a conditioned air and discharging the conditioned air to the growing space and wherein the source of heated water is obtained in a step (b2) by indirect heat exchange against the heated second thermal carrier fluid.

14. The process according to claim 13, wherein the direct contacting in step (c2) takes place in a vertically extending wetted screen through which the source of heated water runs downwards and the feed air passes the wetted screen in a transverse direction.

15. A greenhouse having a roof, a floor, two end walls, two side walls and an elongated mixing space positioned next to an elongated space for conditioned air and wherein the mixing space and the space for conditioned air is separated from a growing space as present within the greenhouse,
wherein the mixing space is fluidly connected to the exterior of the greenhouse by means of one or more openings for ambient air and fluidly connected to the growing space by means of one or more openings,
wherein the mixing space and the space for conditioned air are fluidly connected via one or more water pads and via a parallel air flow path wherein the water pads are positioned parallel to the parallel flow path, and
wherein the growing space comprises a multitude of parallel ventilation conduits and wherein each conduit has an air inlet provided with a ventilator and which air inlet is fluidly connected to the space for conditioned air and wherein the water pads are connected to a supply of chilled water and to a discharge for a used chilled water and wherein the supply of chilled water is fluidly connected to an indirect heat exchanger for cooling a source of water.

16. A greenhouse according to claim 15, wherein the parallel air flow path comprises one or more indirect heating units.

17. The greenhouse according to claim 15, wherein the parallel air flow path is provided with air displacement means.

18. The greenhouse according to claim 15, wherein the openings to the exterior of the greenhouse for ambient air of the mixing space are openings in the roof.

19. The greenhouse according to claim 15, wherein the openings to the exterior of the greenhouse for ambient air of the mixing space are openings in one of the end walls or in one of the side walls.

20. The greenhouse according to claim 15, wherein the mixing space and the space for conditioned air are each a single space.

21. The greenhouse according to claim 15, wherein the mixing space is defined by the roof, an end wall or a side wall, a substantial vertical partition wall spaced apart from the end wall or side wall and running substantially parallel to the end wall or side wall and the floor or a substantially horizontal elevated partition floor spaced apart from the floor.

22. A process according to claim 1 as performed in a greenhouse according to claim 15.

23. A process to reduce or maintain the temperature in a growing space as comprised in a greenhouse and comprising the following steps,
(a) collecting ambient air, air from the growing space and/or mixtures of ambient air and air from the growing space to obtain feed air,
(b) obtaining a cooling medium and a heated second thermal carrier fluid by means of a heat pump, wherein the heat pump transfers thermal energy from a first thermal carrier fluid using a refrigeration cycle to a second thermal carrier fluid acting as a heat sink to obtain the cooling medium and the heated second thermal carrier fluid,
(b1) obtaining a chilled water by reducing a first source of water to a lower temperature by indirect heat exchange against the cooling medium,
(b2) obtaining a source of heated water by indirect heat exchange against the heated second thermal carrier fluid,
(c1) directly contacting part of the feed air with the chilled water obtained in step (b1) during part or all of the night wherein the temperature of the chilled water is lower than the dew point of the feed air and wherein the feed air is cooled thereby obtaining cooled air as a conditioned air and a used chilled water and discharging the conditioned air to the growing space, and
(c2) directly contacting part of the feed air with the source of heated water obtained in step (b2) during part or all of the day wherein the feed air is cooled to a temperature close to the wet-bulb temperature by evaporation of part of the source of heated water thereby obtaining cooled air as a conditioned air and discharging the conditioned air to the growing space.

24. A process to dehumidify the air as present in a growing space as comprised in a greenhouse and comprising the following steps,
(b) obtaining a cooling medium and a heated second thermal carrier fluid by means of a heat pump, wherein the heat pump transfers thermal energy from a first thermal carrier fluid using a refrigeration cycle to a second thermal carrier fluid acting as a heat sink to obtain the cooling medium and the heated second thermal carrier fluid,
(b1) obtaining a chilled water by reducing a first source of water to a lower temperature by indirect heat exchange against the cooling medium,
(cc) directly contacting part of the air from the growing section with the chilled water obtained in step (b1) in a vertically extending wetted screen through which the chilled water runs downwards and the air from the growing section passes the wetted screen in a transverse direction and wherein the temperature of the chilled water is lower than the dew point of the air from the growing section thereby obtaining dehumidified air and discharging the dehumidified air into the growing section.

25. A process according to claim 24, wherein the heated second thermal carrier fluid is directly or via another heat carrier used to heat up the air, irrigation water and/or any plants in the growing section.

26. Use of the greenhouse according to claim 15 to perform a process according to any one of claim 1 in summer and to perform a process according to claim 24 in spring, fall and/or winter.
